(19) United States
(12) Patent Application Publication
(10) Pub. No.: US 2023/0289165 A1
(43) Pub. Date: Sep. 14, 2023

(54) DATA PROCESSING METHOD AND APPARATUS FOR APPLICATION, DEVICE, AND STORAGE MEDIUM

(71) Applicant: Tencent Cloud Computing (Beijing) Co., Ltd., Beijing (CN)

(72) Inventor: Yiwei MA, Beijing (CN)

(21) Appl. No.: 18/299,381

(22) Filed: Apr. 12, 2023

Related U.S. Application Data
(63) Continuation of application No. PCT/CN2021/108730, filed on Jul. 27, 2021.

(30) Foreign Application Priority Data
Feb. 5, 2021 (CN) 2021 10562863.8

(51) Int. Cl. G06F 8/61; G06F 8/71

(52) U.S. Cl. CPC G06F 8/63; G06F 8/71

(57) ABSTRACT

A data processing method and apparatus for an application, a device, and a storage medium. The method is performed by a computer device, and includes: obtaining a software installation package of a target application based on an adjustment instruction for the target application, the software installation package including N database file sets in a one-to-one correspondence with N subservices, and the N database file sets being obtained from N images in a one-to-one correspondence with the N subservices, adjusting, according to P database file sets in the N database file sets, P subservices corresponding to the P database file sets in the N database file sets to a version indicated by a target version identifier, to obtain data information of P adjusted subservices, and storing the data information of the P adjusted subservices in a database to obtain an adjusted target application.

### CROSS-REFERENCE TO RELATED APPLICATION(S)

This application is a continuation application of International Application No. PCT/CN2021/108730, filed on Jul. 27, 2021, which claims priority to Chinese Patent Application No. 202110562863.8, filed with the China National Intellectual Property Administration on May 21, 2021, the disclosures of each of which being incorporated by reference herein in their entireties.

### FIELD

The disclosure relates to the field of applications, and in particular, to a data processing method and apparatus for an application, a device, and a storage medium.

### BACKGROUND

With the continuous development of computer technology, a huge number of applications have emerged in the network. During actual application, various applications often require adjustment (such as updating or rolling back) over time to meet current requirements. For example, a developer needs to update a program after fixing program vulnerabilities, or when a major error occurs in a new version of program, it is necessary to roll back to a previous version. Each application usually includes a plurality of subservices, and during adjustment of the application, all the subservices need to be adjusted one by one, resulting in relatively low efficiency.

### SUMMARY

Some embodiments provide a data processing method and apparatus for an application, a device, and a storage medium, to favorably improve the efficiency of application adjustment.

Some embodiments provide a data processing method for an application, the method being performed by a computer device, and the method including: obtaining a software installation package of a target application based on an adjustment instruction for the target application, the adjustment instruction carrying a target version identifier, the target application including N subservices, the software installation package including N database file sets in a one-to-one correspondence with the N subservices, the N database file sets being obtained from N images in a one-to-one correspondence with the N subservices, and N being a positive integer; adjusting, according to P database file sets in the N database file sets, P subservices in the N subservices to a version indicated by the target version identifier, to obtain data information of P adjusted subservices, P being a positive integer, and P being less than or equal to N; and storing the data information of the P adjusted subservices in a database to obtain an adjusted target application.

Some embodiments provide a data processing apparatus for an application, including: at least one memory configured to store program code; and at least one processor configured to read the program code and operate as instructed by the program code, the program code comprising: an obtaining unit, configured to obtain a software installation package of a target application based on an adjustment instruction for the target application, the adjustment instruction carrying a target version identifier, the target application including N subservices, the software installation package including N database file sets in a one-to-one correspondence with the N subservices, the N database file sets being obtained from N images in a one-to-one correspondence with the N subservices, and N being a positive integer; and a processing unit, configured to adjust, according to P database file sets in the N database file sets, P subservices in the N subservices to a version indicated by the target version identifier, to obtain data information of P adjusted subservices, P being a positive integer, and P being less than or equal to N; and store the data information of the P adjusted subservices in a database to obtain an adjusted target application.

Some embodiments provide a computer device, including: a storage apparatus and a processor; the storage apparatus storing a computer program; and the processor executing the computer program to implement the data processing method for an application described above.

Some embodiments provide a non-transitory computer-readable storage medium, storing computer code that when executed by at least one processor causes the at least one processor to implement the data processing method according to the foregoing embodiments.

Some embodiments provide a computer program product or a computer program, including computer instructions, the computer instructions being stored in a computer-readable storage medium. A processor of a computer device reads the computer instructions from the computer-readable storage medium, and executes the computer instructions, to cause the computer device to perform the data processing method for an application described above.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of a scenario of data processing for an application according to some embodiments.

FIG. 2 is a diagram of an architecture of data processing for an application according to some embodiments.

FIG. 3 is a schematic flowchart of a data processing method for an application according to some embodiments.

FIG. 4 is a schematic flowchart of another data processing method for an application according to some embodiments.

FIG. 5 is a schematic diagram of upgrading all subservices of a target application to a version indicated by a target version identifier according to some embodiments.

FIG. 6 is a schematic diagram of rolling back all subservices of a target application to a version indicated by a target version identifier according to some embodiments.

FIG. 7 is a flowchart of data processing for an application according to some embodiments.

FIG. 8 is a schematic structural diagram of a data processing apparatus according to some embodiments.

FIG. 9 is a schematic structural diagram of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict.

In some embodiments, a software installation package of a target application is obtained based on an adjustment instruction for the target application, the software installation package including N database file sets in a one-to-one correspondence with N subservices, and the N database file sets being obtained from N images in a one-to-one correspondence with the N subservices; P subservices corresponding to P database file sets in the N database file sets are adjusted, according to the P database file sets in the N database file sets, to a version indicated by a target version identifier, to obtain data information of P adjusted subservices; and the data information of the P adjusted subservices is stored in a database to obtain an adjusted target application. A plurality of subservices in an application can be adjusted in batches by using N database file sets obtained from N images, thereby improving the efficiency of application adjustment

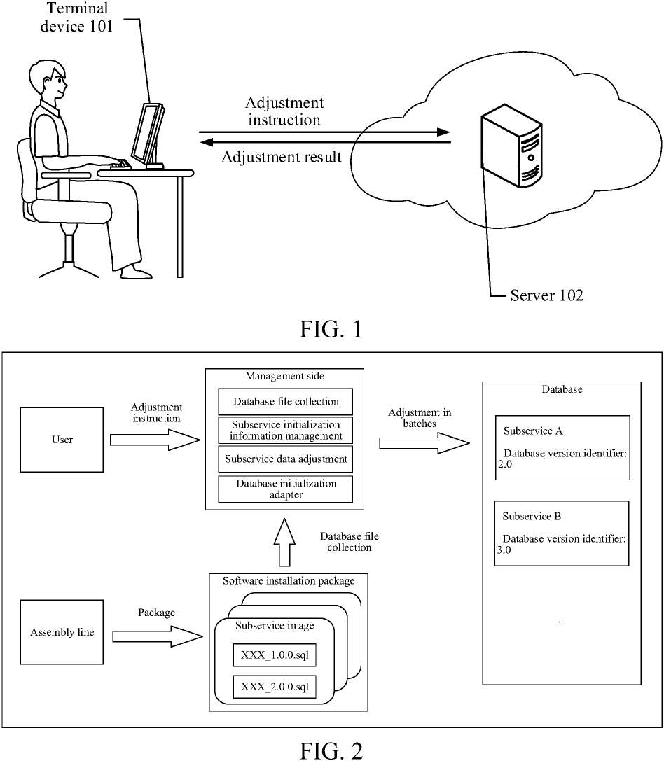

FIG. 1 is a diagram of a scenario of data processing for an application according to some embodiments. As shown in FIG. 1, the scenario of data processing for an application may include a terminal device 101 and a server 102. The terminal device 101 is a device used by a user. There may be one or more terminal devices 101. The form of the terminal device 101 is for exemplary purpose only. The terminal device 101 may include, but is not limited to: a smartphone (such as an Android mobile phone or an iOS mobile phone), a tablet computer, a portable personal computer, a mobile Internet device (MID), or other devices. The terminal device is usually configured with a display device. The display device may be a display, a display screen, a touchscreen, or the like. The touchscreen may be a touch screen, a touch panel, or the like. This is not limited herein.

The server 102 may be an independent physical server, or a server cluster or distributed system composed of a plurality of physical servers, or may be a cloud server that provides cloud services, cloud databases, cloud computing, cloud functions, cloud storage, network services, cloud communication, middleware services, domain name services, security services, content delivery networks (CDNs), big data and artificial intelligence platforms, and other basic cloud computing services. In addition, the server 102 may be a network node in a blockchain network. The terminal device 101 and the server 102 may be directly or indirectly connected in a wired or wireless communication manner. This is not limited herein. In some embodiments, the user (such as the developer) may send an adjustment instruction to the server 102 through the terminal device 101, so that the server 102 performs adjustment (such as upgrading or rolling back) on a target application deployed in the server 102 according to the adjustment instruction.

Quantities of terminal devices and servers in a processing system for an application shown in FIG. 1 are merely examples. For example, there may be a plurality of terminal devices and a plurality of servers. The quantities of the terminal devices and servers are not limited herein.

In some embodiments, the diagram of the scenario of data processing for an application shown in FIG. 1 may include only the terminal device 101. The user may input an adjustment instruction into the terminal device 101, so that the terminal device 101 adjusts a subservice in a target application in the terminal device according to the adjustment instruction. For example, the user upgrades an application A by clicking an “upgrade” button of the application A during use of a computer.

FIG. 2 is a diagram of an architecture of data processing for an application according to some embodiments. In some embodiments, the method is applicable to a management side, and the management side is a computer device. The computer device may be, for example, a terminal device used by some users mentioned above, or some server with special functions. The method includes the following operations:

(1) The computer device (that is, the management side) obtains a software installation package of a target application based on an adjustment instruction for the target application (for example, the computer device detects an adjustment instruction input by a user).

The adjustment instruction carries a target version identifier (that is, a version of the target application needs to be adjusted, through the software installation package, to a version indicated by the target version identifier). The target application includes N subservices (such as a verification subservice, a payment subservice, and a multimedia rendering subservice). The software installation package includes N database file sets in a one-to-one correspondence with the N subservices. The N database file sets are obtained from N images in a one-to-one correspondence with the N subservices, and N is a positive integer. An image is similar to a file compression package, and a series of specific files (such as database files) are manufactured into a single file in a particular format for subsequent use.

It can be learned from FIG. 2 that, the installation package of the target application may be obtained by packaging the N images corresponding to the N subservices in the target application and related configuration files through an automated assembly line. The images are developed and provided by a developer. In some embodiments, the computer device obtains a target image corresponding to a target subservice in the N subservices of the target application; creates a target container based on the target image, and extracts a database file from the target image through the target container, to obtain a database file set of the target subservice; and packages the N database file sets to obtain the software installation package of the target application after obtaining the N database file sets of the N subservices according to the foregoing operation. The container is configured to obtain the database file included in the image from the image.

The software installation package is sent by a target computer device to the computer device. The target computer device is configured to obtain a target image corresponding to the target subservice in the N subservices; create a target container based on the target image, and extract a database file from the target image through the target container, to obtain the database file set of the target subservice, the database file set of the target subservice including: database files of different versions under the target subservice, the database file in the database file set of the target subservice being named according to a version identifier to which the database file belongs; and generate the software installation package of the target application according to the database file set of the target subservice.

For example, assuming that a computer device for performing the data processing method for an application is a first computer device, a computer device for generating an installation package of a target application may be the first computer device or a second computer device. For example, the first computer device may be a terminal, and the second computer device may be a server. For example, the first computer device and the second computer device refer to different runtime environments.

Each image includes at least one database file, and an identifier of each database file carries a version identifier (such as a version number) corresponding to the database file. In some embodiments, each database file needs to be named according to a preset syntax rule and stored in a specified path, so that the computer device can recognize and obtain the corresponding database file during the adjustment of the target application according to the software installation package of the target application.

(2) The computer device adjusts, according to P database file sets in the N database file sets, P subservices in the N subservices to a version indicated by the target version identifier, to obtain data information of P adjusted subservices, P being a positive integer, and P being less than or equal to N.

When P=N, the computer device performs adjustment (such as upgrading to a target version or rolling back to a target version) on all the subservices (the N subservices) of the target application according to the N database file sets. When P<N, the computer device adjusts the P subservices in the target application according to the P database file sets. For example, the computer device adjusts P subservices corresponding to a payment function in the target application according to the software installation package of the target application.

It can be learned from FIG. 2 that, the process in which the computer device adjusts the target application according to the software installation package of the target application includes: database file collection (that is, reading a database file required for adjustment from the software installation package of the target application); subservice initialization information management (such as configuring related parameters before the adjustment of the subservices); subservice data adjustment (that is, adjustment of data of a to-be-adjusted subservice according to a database file corresponding to the to-be-adjusted subservice); and a database initialization adapter (that is, determining an initialization adapter matching a type of the database file).

(3) The computer device stores the data information of the P adjusted subservices in a database to obtain an adjusted target application.

It can be learned from FIG. 2 that, after adjusting the P subservices in batches according to the software installation package of the target application, the computer device stores the adjusted subservices in a database to obtain an adjusted target application. In some embodiments, the adjusted subservice carries a database version identifier of the subservice after adjustment.

In some embodiments, a software installation package of a target application is obtained based on an adjustment instruction for the target application, the software installation package including N database file sets in a one-to-one correspondence with N subservices, and the N database file sets being obtained from N images in a one-to-one correspondence with the N subservices; P subservices corresponding to P database file sets in the N database file sets are adjusted, according to the P database file sets in the N database file sets, to a version indicated by a target version identifier, to obtain data information of P adjusted subservices; and the data information of the P adjusted subservices is stored in a database to obtain an adjusted target application. In some embodiments, a plurality of subservices in an application can be adjusted in batches by using N database file sets obtained from N images, thereby improving the efficiency of application adjustment.

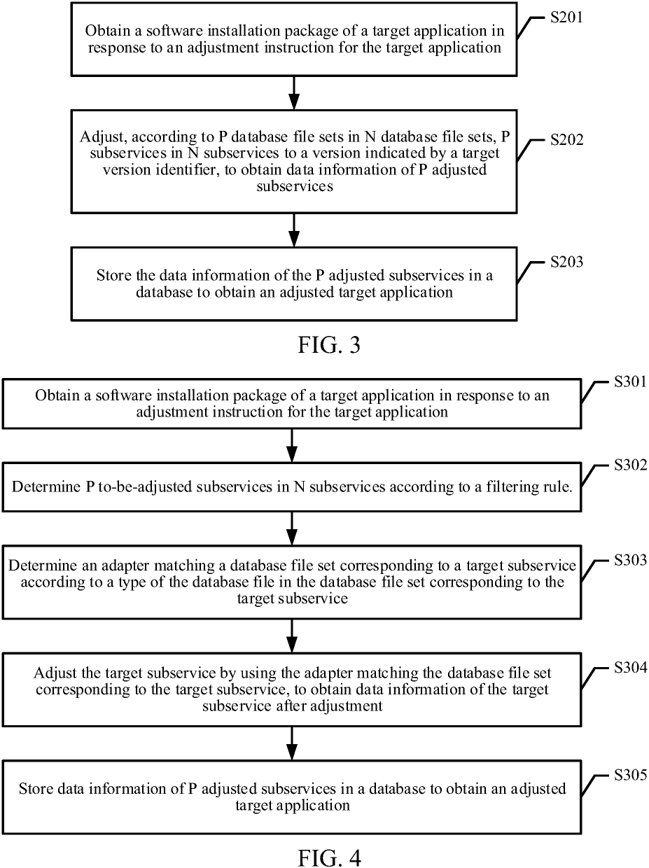

FIG. 3 is a schematic flowchart of a data processing method for an application according to some embodiments. In some embodiments, the method is performed by a computer device. The computer device may be, for example, a terminal device used by some users mentioned above, or some server with special functions. The method includes the following operations:

S201: Obtain a software installation package of a target application in response to, or based on, an adjustment instruction for the target application. The adjustment instruction carries a target version identifier. The target version identifier is used for indicating a version to which the target application needs to be adjusted. For example, the target version identifier indicates a version to which the target application needs to be upgraded, or the target version identifier is indicates a version to which the target application needs to be rolled back. For example, assuming that a current version identifier of the target application is 1.2.1, and the target version identifier carried in the adjustment instruction is 3.0.1, the terminal device upgrades the target application to the version 3.0.1 according to the adjustment instruction. For another example, assuming that a current version identifier of the target application is 4.1.1, and the target version identifier carried in the adjustment instruction is 3.0.1, the terminal device rolls back the target application to the version 3.0.1 according to the adjustment instruction.

The target application includes N subservices, and the N subservices may be divided, according to a division rule (such as being divided based on functions of the subservices), into M subservice sets. M and N are positive integers, and M is less than or equal to N. The software installation package of the target application includes N database file sets in a one-to-one correspondence with the N subservices. The N database file sets are obtained from N images in a one-to-one correspondence with the N subservices. Each image may include one or more database files. An identifier of each database file carries a version identifier (such as a version number) corresponding to the database file. The database file is used for describing operation content such as detailed table creation of a subservice initialization database.

In some embodiments, each database file needs to be named according to a preset syntax rule and stored in a specified path, so that the computer device can recognize and obtain the corresponding database file during the adjustment of the target application according to the software installation package of the target application.

S202: Adjust, according to P database file sets of the N database file sets, P subservices of the N subservices to a version indicated by the target version identifier, to obtain data information of P adjusted subservices, P being a positive integer, and P being less than or equal to N.

In some embodiments, the computer device determines P to-be-adjusted subservices in the N subservices according to a filtering rule. The filtering rule may be formulated by a user according to an actual situation. For example, based on the user needing to adjust the entire target application, the filtering rule may be set to select all. For another example, based on the user needing to adjust some of the subservices in the target application, a filtering rule may be formulated according to an identifier of a subservice that needs to be adjusted (such as a name or an identification number of the subservice).

After determining the P to-be-adjusted subservices, the computer device obtains a database file set corresponding to each of the P subservices from the software installation package of the target application. The database file set corresponding to each subservice includes at least one version of database files under the subservice. Each database file is named according to a version identifier to which the database file belongs.

In some embodiments, the computer device obtains a target image corresponding to the target subservice in the N subservices of the target application; creates a target container based on the target image, and extracts a database file from the target image through the target container, to obtain the database file set of the target subservice; and packages the N database file sets to obtain the software installation package of the target application after obtaining the N database file sets of the N subservices according to the foregoing operation. For example, a subservice 1 corresponds to an image A, and it is assumed that the image A includes database files with a version identifier 1.0.0 to a version identifier 4.3.1. For example, the computer device creates a container A based on the image A, and extracts (copies) the database files with the version identifier 1.0.0 to the version identifier 4.3.1 from the image A through the container A, to obtain a database file set of the subservice 1. After obtaining database file sets of all subservices of the target application, the computer device packages the database file sets to obtain the software installation package of the target application. In some embodiments, after extracting and obtaining the database file set from the target image, the computer device deletes the created target container to reduce unnecessary resource occupation.

After obtaining the database file set corresponding to each of the P subservices from the software installation package, the computer device adjusts the P subservices according to the database file set corresponding to each of the P subservices, to obtain data information of P adjusted subservices. In some embodiments, the computer device determines an adapter matching a type of a database file in the database file set corresponding to the target subservice, and calls the adapter to execute the database file in the database file set corresponding to the target subservice, to obtain the data information of the target subservice after adjustment. During the adjustment, the computer device first sifts out database files meeting a condition from the database file set according to a current version number and a target version number of the target subservice, and calls the adapter to execute the database files meeting the condition in a target order to adjust the target subservice, to obtain the data information of the target subservice after adjustment. For example, assuming that a current version identifier of the target subservice current is 2.1.1, and a target version identifier is 3.0.1, the computer device sifts out database files with a version identifier 2.1.2 to the version identifier 3.0.1 from the database file set corresponding to the target subservice, and calls the adapter to sequentially execute the database files with the version identifier 2.1.2 to the version identifier 3.0.1 in ascending order. For another example, assuming that a current version identifier of the target subservice current is 2.1.1, and a target version identifier is 1.0.1, the computer device sifts out database files with the version identifier 1.0.1 to a version identifier 2.1.0 from the database file set corresponding to the target subservice, and calls the adapter to sequentially execute the database files with the version identifier 2.1.0 to the version identifier 1.0.1 in descending order.

S203: Store the data information of the P adjusted subservices in a database to obtain an adjusted target application. In some embodiments, the database stores data information of the N subservices of the target application, and data information of each subservice carries a current version identifier of the subservice. After the computer device adjusts the subservice according to the software installation package of the target application, the current version identifier of the subservice is also updated accordingly to a version identifier after the adjustment, so that next time when a subservice needs to be adjusted, the computer device can obtain a current version identifier of the subservice from the database.

In some embodiments, a software installation package of a target application is obtained based on an adjustment instruction for the target application, the software installation package including N database file sets in a one-to-one correspondence with N subservices, and the N database file sets being obtained from N images in a one-to-one correspondence with the N subservices; P subservices corresponding to P database file sets in the N database file sets are adjusted, according to the P database file sets in the N database file sets, to a version indicated by a target version identifier, to obtain data information of P adjusted subservices; and the data information of the P adjusted subservices is stored in a database to obtain an adjusted target application. It can be learned that, the N database file sets in a one-to-one correspondence with the N subservices can be obtained by using the images corresponding to the subservices, and a plurality of subservices in an application can be adjusted in batches based on the N database file sets, thereby improving the efficiency of application adjustment.

FIG. 4 is a schematic flowchart of another data processing method for an application according to some embodiments. In some embodiments, the method is performed by a computer device. The computer device may be, for example, a terminal device used by some users mentioned above, or some server with special functions. The method includes the following operations:

S301: Obtain a software installation package of a target application based on an adjustment instruction for the target application. The target application includes N subservices. The software installation package of the target application includes the N database file sets in a one-to-one correspondence with the N subservices. A database file set corresponding to the target subservice may include one or more database files (that is, include database files of different versions under the target subservice). Each database file is named according to a version identifier to which the database file belongs.

In some embodiments, the process in which the computer devices obtains the software installation package of the target application includes: obtaining a target image corresponding to the target subservice in the N subservices; and creating a target container based on the target image, and extracting a database file from the target image through the target container, to obtain the database file set of the target subservice. In some embodiments, the computer device creates a target container, and copies the database file in the target image to the target container, to obtain the database file set of the target subservice. After obtaining the N database file sets respectively corresponding to the N subservices, the computer device packages the N database file sets into the software installation package of the target application.

Specifically, each image may include database files (such as database files to be upgraded and database files to be rolled back) with a plurality of adjustment policies (such as upgrading or rolling back). The computer device may add the database files with the plurality of adjustment policies to the same database file set, to obtain the N database file sets respectively corresponding to the N subservices. In some embodiments, database files with different adjustment policies may be added to different database file sets according to the adjustment policies. For example, database files to be upgraded are added to an upgrade database file set, and database files to be rolled back are added to a rollback database file set. Further, N upgrade database file sets respectively corresponding to the N subservices are packaged in an upgrade software installation package, and N rollback database file sets respectively corresponding to the N subservices are packaged in a rollback software installation package.

In some embodiments, the N subservices belong to M service types, M is a positive integer, and M is less than or equal to N; and the software installation package of the target application is obtained by classifying and packaging the N database file sets according to the M service types. In other words, the software installation package of the target application preprocesses (such as classifying or sorting in advance) the N database file sets during packaging of the N database file sets. Compared with storing the N database file sets directly in a folder, preprocessing the N database file sets can allow the computer device to obtain a required database file set more efficiently during adjustment of the target application adjust according to the software installation package of the target application.

In some embodiments, it is assumed that each subservice in the target application is deployed according to a sorting rule, or that each subservice corresponds to a sequence number. In this case, during the packaging of the software installation package of the target application, the database file sets may be sorted and packaged according to the sorting rule or the sequence numbers. It can be understood that, the computer device can rapidly obtain a required database file set from the software installation package of the target application according to the sorting rule or the sequence numbers, without any need to perform traversal search on the database file sets in the software installation package of the target application each time a database file set needs to be obtained, thereby improving the efficiency of adjusting the target application and effectively saving computer resources.

In another embodiment, during the packaging of the N database file sets, database files belonging to different functions are stored in different directories, so that the computer device can rapidly obtain a required database file during the adjustment of the target application according to the software installation package of the target application.

The software installation package corresponding to the target application is packaged in advance and placed on the computer device (for example, stored in a memory) before the execution of the adjustment instruction. In some embodiments, when one or more subservices in the target application need to be upgraded to a higher version, database file sets required for the upgrade need to be packaged through an assembly line in an appointment manner, and a software installation package obtained through packaging is placed on the computer device. For example, assuming that the user needs to upgrade an application 1 from version 1.0 to version 2.1, before an adjustment instruction is input, database file sets of subservices in the application 1 from version 1.0 to version 2.1 need to be packaged through an assembly line, and a software installation package obtained through packaging is placed on the computer device.

S302: Determine P to-be-adjusted subservices in the N subservices according to a filtering rule. The filtering rule may be formulated by a user according to an actual situation. For example, based on the user needing to adjust the entire target application, the filtering rule may be set to select all (that is, full adjustment (involving all subservices) is to be performed on the target application). For another example, based on the user needing to adjust some of the subservices in the target application, a filtering rule may be formulated according to an identifier of a subservice that needs to be adjusted (such as a name or an identification number of the subservice) (for example, only a subservice whose name includes a target field is to be adjusted or only a subservice whose identification number is less than a target identification number is to be adjusted).

S303: Determine an adapter matching a database file set corresponding to a target subservice according to a type of the database file in the database file set corresponding to the target subservice. The target subservice may be any subservice in the P to-be-adjusted subservices determined in the N subservices according to the filtering rule. The type of the database file may include, but is not limited to: a MySQL type or a TDSQL type.

During actual deployment, types of imported database files may be different and database operation statements that need to be executed may be different. For example, there are some differences between a MySQL database and a TDSQL database. For a scenario where there are differences databases, the computer device can appropriately modify a file identifier (such as a file name) of the database file. For example, assuming that in the MySQL database, a file identifier of an initialization database file is “init_x.x.x.sql”, in order to adapt to the TDSQL database, the computer device can only modify the file identifier of the initialization database file to “tdsql_init_x.x.x.sql”. During the adjustment of the target application, the user specifies a database file type in the software installation package of the target application. The computer device can find all database files of the database file type according to the foregoing syntax rule, and adjust the target application according to the database files.

S304: Adjust the target subservice by using the adapter matching the database file set corresponding to the target subservice, to obtain data information of the target subservice after adjustment.

Operation 303 and operation 304 are repeated to adjust the P subservices in the N subservices to the version indicated by the target version identifier.

In some embodiments, the computer device determines a version identifier interval according to a current version identifier of the target subservice and the target version identifier. For example, assuming that a current version identifier of a subservice 1 is 2.1.1, and the target version identifier is 3.0.1, the computer device determines that the version identifier interval is 2.1.2 to 3.0.1 according to the current version identifier 2.1.1 of the subservice 1 and the target version identifier 3.0.1. Similarly, assuming that the current version identifier of the subservice 1 is 2.1.1, and the target version identifier is 1.2.1, the computer device determines that the version identifier interval is 1.2.1 to 2.1.0 according to the current version identifier 2.1.1 of the subservice 1 and the target version identifier 1.2.1.

After the version identifier interval is determined, the adapter matching the database file set corresponding to the target subservice is called intelligently, and at least one database file in the database file set corresponding to the target subservice is executed, to obtain the data information of the target subservice after adjustment, a version identifier of the at least one database file belonging to the version identifier interval. For example, it is assumed that the version identifier interval is 1.2.1 to 2.1.0, and the database file set corresponding to the target subservice includes: a database file with a version identifier of 1.0.1, a database file with a version identifier of 1.3.1, a database file with a version identifier of 2.0.1, a database file with a version identifier of 2.1.2, and a database file with a version identifier of 3.2.1. In this case, the adapter matching the database file set corresponding to the target subservice is called intelligently, and the database file with the version identifier of 1.3.1 and the database file with the version identifier of 2.0.1 are executed, to obtain the data information of the target subservice after adjustment.

In some embodiments, the database file set corresponding to the target subservice includes a plurality of database files belonging to the version identifier interval. The computer device calls the adapter matching the database file set corresponding to the target subservice, and sequentially executes to-be-executed database files in a target order, to obtain the data information of the target subservice after adjustment.

The to-be-executed database files includes database files belonging to the version identifier interval in the database file set corresponding to the target subservice. The target order is determined according to an adjustment policy of the target subservice, and the adjustment policy of the target subservice is determined according to the current version identifier of the target subservice and the target version identifier.

In some embodiments, the adjustment policy includes upgrade and rollback. If the current version identifier of the target subservice is smaller than the target version identifier, the computer device sets the adjustment policy to upgrade, and a target order corresponding to the upgrade is an ascending order (from an old version to a new version). If the current version identifier of the target subservice is greater than the target version identifier, the computer device sets the adjustment policy to rollback, and a target order corresponding to the rollback is a descending order (from a new version to an old version). During actual application, a drop or delete statement is not allowed in a database file user for the upgrade.

In some embodiments, assuming that the version identifier of the target subservice current is 2.1.1, and the target version identifier is 3.0.1, the computer device determines that the adjustment policy of the target subservice is an upgrade. The computer device sifts out database files with a version identifier 2.1.2 to the version identifier 3.0.1 from the database file set corresponding to the target subservice, and calls the adapter to sequentially execute the database files with the version identifier 2.1.2 to the version identifier 3.0.1 in ascending order. For another example, assuming that the current version identifier of the target subservice current is 2.1.1, and the target version identifier is 1.0.1, the computer device determines that the adjustment policy of the target subservice is rollback. The computer device sifts out database files with the version identifier 1.0.1 to a version identifier 2.1.0 from the database file set corresponding to the target subservice, and calls the adapter to sequentially execute the database files with the version identifier 2.1.0 to the version identifier 1.0.1 in descending order.

In another embodiment, an identifier of each database file carries an adjustment type field. The computer device determines an adjustment policy according to the current version identifier of the target subservice and the target version identifier. Specifically, the computer device determines a target field according to the current version identifier of the target subservice and the target version identifier, the target field being used for indicating the adjustment policy. Specifically, if the current version identifier of the target subservice is smaller than the target version identifier, the computer device determines a first field (such as an “init” field) as the target field. If the current version identifier of the target subservice is greater than the target version identifier, the computer device determines a second field (such as an “undo” field) as the target field. The first field and the second field are for exemplary purpose only, and do not constitute any actual limitations. For example, the first field may be “create”, and the second field may be “delete”.

To-be-executed database files are sifted out from the database file set corresponding to the target subservice according to the adjustment policy. An adjustment type field of the to-be-executed database file matches the adjustment policy. Specifically, the computer device sifts out, from the database file set corresponding to the target subservice according to the target field, database files with file identifiers carrying the target field and version identifiers belonging to the version identifier interval, and determines the database files as to-be-executed database files. For example, it is assumed that the version identifier interval is determined to be 1.2.1 to 2.1.0, the target field is “init”, and database files included in a database file set corresponding to a subservice 1 are: init_1.0.1.sql, init_1.2.3.sql, init_2.0.1.sql, init_3.0.1.sql, undo_1.0.2.sql, undo_1.3.1.sql, undo_2.2.3.sql, and undo_3.1.3.sql. In this case, the computer device determines the database files init_1.2.3.sql and init_2.0.1.sql as to-be-executed database files.

Further, the computer device calls the adapter matching the database file set corresponding to the target subservice, and executes the to-be-executed database files, to obtain the data information of the target subservice after adjustment.

During actual application, if the computer device detects that there is an operation (such as initializing the database) of adjusting the database currently, database files are uniformly stored in a specified directory of the image. For example, the database files are uniformly stored in a directory /usr/local/services/sql, and file extensions of the database files are unified to “.sql”. Further, the stability of the target application during adjustment can be improved by standardizing an identifier (such as naming) of the database file. In some embodiments, a database file to be upgraded may be named as: init_version number.sql, for example, init_2.5.0.sql. A database file to be rolled back may be named as: undo_version number.sql, for example, undo_2.5.0.sql. File naming is only a manner to facilitate cognition and use, and the naming manner is not limited to one naming manner in this solution. For example, create_x.sql or delete_x.sql may be used for naming.

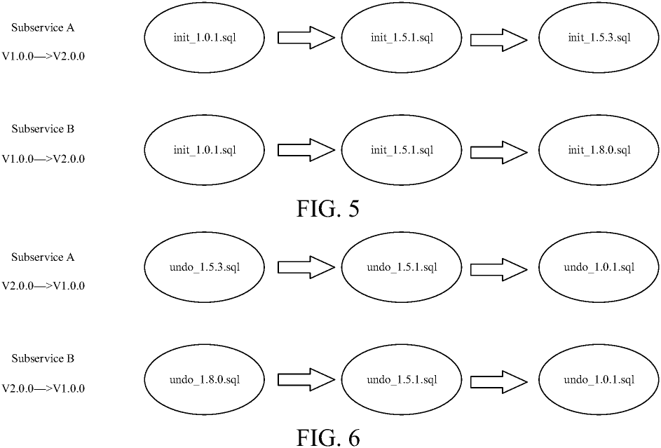

FIG. 5 is a schematic diagram of upgrading all subservices of a target application to a version indicated by a target version identifier according to some embodiments. If a version is already deployed in a computer device, and an identifier of a target version carried in an adjustment instruction is greater than the deployed version (that is, the current version), upgrading may be performed in a manner shown in FIG. 5: The computer device finds a database file set corresponding to each subservice. A database file set of a target subservice includes all database files carrying an “init” field between a deployed version of the target subservice and the target version. Then, the computer device calls an adapter matching a type of the database file, and executes all the database files carrying the “init” field between the deployed version of the target subservice and the target version in the database file set of the target subservice in ascending order of sequence numbers of version identifiers of the database files, to obtain data information of the target subservice after adjustment.

As shown in FIG. 5, it is assumed that the adjustment instruction indicates to adjust the target application from version 1.0.0 to version 2.0.0, the target application includes a subservice A and a subservice B, and in a database file set corresponding to the subservice A, database files with an adjustment type field of “init” and version identifiers belonging to a version identifier interval of 1.0.0 to 2.0.0 are three database files: init_1.0.1.sql, init_1.5.1.sql, and init_1.5.3.sql. In this case, the computer device calls an adapter matching a type of the database files, and upgrades the subservice A to the version indicated by the target version identifier in an order of init_1.0.1.sql—>init_1.5.1.sql—>init_1.5.3.sql. Similarly, in a database file set corresponding to the subservice B, database files with the adjustment type field of “init” and version identifiers belonging to the version identifier interval of 1.0.0 to 2.0.0 are three database files: init_1.0.1.sql, init_1.5.1.sql, and init_1.8.0.sql. In this case, the computer device calls an adapter matching a type of the database files, and upgrades the subservice B to the version indicated by the target version identifier in an order of init_1.0.1.sql->init_1.5.1.sql->init_1.8.0.sql. Similarly, the computer device may upgrade all subservices in containers of the subservices to the version indicated by the target version identifier.

FIG. 6 is a schematic diagram of rolling back all subservices of a target application to a version indicated by a target version identifier according to some embodiments. If a version is already deployed in a computer device, and an identifier of a target version carried in an adjustment instruction is smaller than the deployed version (that is, the current version), the rollback may be performed in a manner shown in FIG. 6: The computer device finds a database file set corresponding to each subservice. A database file set of a target subservice includes all database files carrying an “undo” field between a deployed version of the target subservice and the target version. Then, the computer device calls an adapter matching a type of the database file, and executes all the database files carrying the “undo” field between the deployed version of the target subservice and the target version in the database file set of the target subservice in descending order of sequence numbers of version identifiers of the database files, to obtain data information of the target subservice after adjustment.

As shown in FIG. 6, it is assumed that the adjustment instruction indicates to adjust the target application from version 2.0.0 to version 1.0.0, the target application includes a subservice A and a subservice B, and in a database file set corresponding to the subservice A, database files with an adjustment type field of “undo” and version identifiers belonging to a version identifier interval of 1.0.0 to 2.0.0 are three database files: undo_1.0.1.sql, undo_1.5.1.sql, and undo_1.5.3.sql. In this case, the computer device calls an adapter matching a type of the database files, and rolls back the subservice A to the version indicated by the target version identifier in an order of undo_1.5.3.sql—>undo_1.5.1.sql—>undo_1.0.1.sql. Similarly, in a database file set corresponding to the subservice B, database files with the adjustment type field of “undo” and version identifiers belonging to the version identifier interval of 1.0.0 to 2.0.0 are three database files: undo_1.0.1.sql, undo_1.5.1.sql, and undo_1.8.0.sql. In this case, the computer device calls an adapter matching a type of the database files, and rolls back the subservice B to the version indicated by the target version identifier in an order of undo_1.8.0.sql—>undo_1.5.1.sql—>undo_1.0.1.sql. Similarly, the computer device may roll back all subservices in containers of the subservices to the version indicated by the target version identifier.

It can be understood that, for a scenario in which some functional modules in the target application are intended to be upgraded individually, a user can configure an identifier (such as a name) of a subservice and a version identifier (such as a version number) of the subservice to specify a subservice that needs to be adjusted. The computer device individually adjusts the subservice specified by the user according to the foregoing adjustment policy without affecting other subservices.

In some embodiments, data information of each of the P subservices carries a current version identifier. Further, based on successful adjustment of the P subservices, each of current version identifiers of the P subservices is replaced with the target version identifier, to obtain data information of P adjusted subservices. For example, in data information of the subservice 1 before the adjustment, the version identifier is 1.2.1, and the target version identifier is 2.0.1. In this case, based on successful adjustment of the subservice 1, the computer device updates the version identifier in the data information of the subservice 1 to 2.0.1.

S305: Store the data information of the P adjusted subservices in a database to obtain an adjusted target application. For implementation of operation S305, refer to the implementation of operation S203 in FIG. 3. Details are not described herein again.

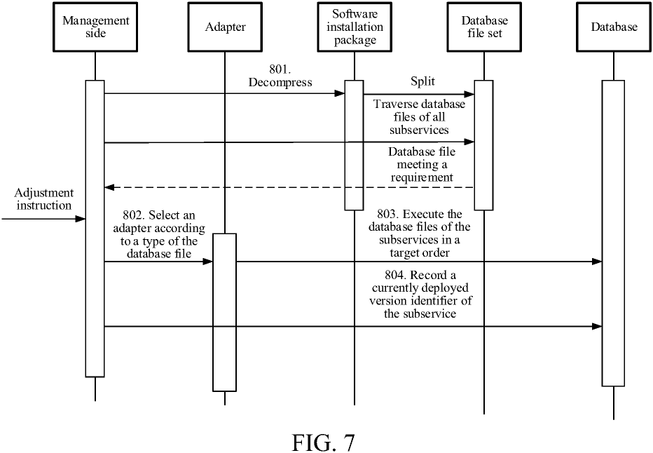

FIG. 7 is a flowchart of data processing for an application according to some embodiments. The data processing method for an application provided in some embodiments is described below with reference to FIG. 2 to FIG. 7. Operation 801. The computer device decompresses the software installation package of the target application to obtain a database file set of each subservice in the target application through splitting, the database file set of the each subservice in the target application being obtained from an image of the each subservice in the target application by creating a container, and the computer device traverses database files in the database file sets according to the adjustment instruction, to obtain a database file meeting a requirement. Operation 802. The computer device selects, according to a type of the database file, an initialization adapter matching the type of the database file. Different database files correspond to different adapters (such as a MySQL adapter and a TDSQL adapter). In addition, the computer device further performs some related adaptation operations (such as syntax conversion) according to the type of the database file. Operation 803. The computer device calls the initialization adapter to execute, in the container, the database files in the database file set of the each subservice according to magnitude of a version number sequence (in ascending order during upgrade, and in descending order during rollback). In some embodiments, database files in a database file set are sifted out according to a filtering rule specified by a user. Operation 804. A currently deployed version number is stored in the database for each subservice, and when detecting successful adjustment, the computer device updates the currently deployed version number to the version number indicated by the target version identifier, to facilitate comparison with a version number carried in the adjustment instruction during subsequent adjustment of the target application.

In some embodiments, the computer device creates a container to obtain the database file set corresponding to each subservice in the target application from an image corresponding to the each subservice, allowing the each subservice to perform operations only on a database and a table of the each subservice, and different subservices do not interfere with one another, so that a plurality of subservices in the target application can be adjusted in batches (that is, in terms of centralized management of the databases, the databases can be upgraded or rolled back in batches). Preprocessing (naming and ordering) the database file sets during the packaging of the software installation package can further improve the efficiency of adjusting the target application. Different adapters are selected to adapt to different types of database files, thereby improving universality. In addition, a subservice developer needs only to provide a service container image according to a regulation, without any need to provide additional content. The container image is containerized deployment of required content, with low transformation costs and low intrusion.

The methods of some embodiments are described in detail above. To better implement the foregoing solutions, correspondingly, an apparatus according to some embodiments is provided below.

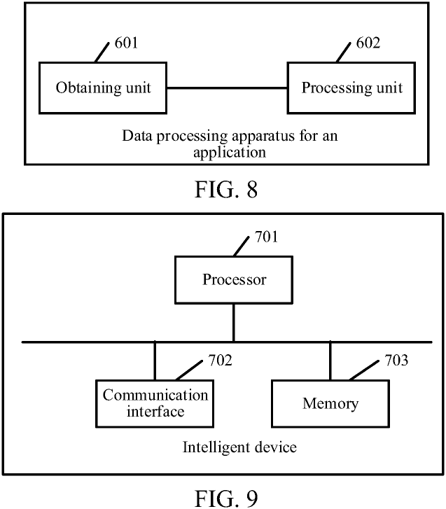

FIG. 8 is a schematic structural diagram of a data processing apparatus for an application according to some embodiments. The apparatus may be mounted on the terminal device 101 or the server 102 shown in FIG. 1. The data processing apparatus for an application shown in FIG. 8 may be configured to perform some or all functions in the method embodiments described above in FIG. 3 and FIG. 4. Detailed descriptions of units are as follows:

An obtaining unit 601 is configured to obtain a software installation package of a target application based on an adjustment instruction for the target application, the adjustment instruction carrying a target version identifier, the target application including N subservices, the software installation package including N database file sets in a one-to-one correspondence with the N subservices, the N database file sets being obtained from N images in a one-to-one correspondence with the N subservices, and N being a positive integer.

The processing unit 602 is configured to adjust, according to P database file sets in the N database file sets, P subservices in the N subservices to a version indicated by the target version identifier, to obtain data information of P adjusted subservices, P being a positive integer, and P being less than or equal to N; and store the data information of the P adjusted subservices in a database to obtain an adjusted target application.

In some embodiments, the processing unit 602 is specifically configured to:

determine P to-be-adjusted subservices in the N subservices according to a filtering rule;

determine an adapter matching a database file set corresponding to a target subservice according to a type of the database file in the database file set corresponding to the target subservice, the target subservice being any subservice in the P to-be-adjusted subservices determined in the N subservices according to the filtering rule; adjust the target subservice by using the adapter matching the database file set corresponding to the target subservice, to obtain data information of the target subservice after adjustment; and repeat this operation to adjust the P subservices in the N subservices to the version indicated by the target version identifier.

In some embodiments, each image includes at least one database file, and the at least one database file each carries an identifier of a corresponding database. The processing unit 602 is specifically configured to:

determine a version identifier interval according to a current version identifier of the target subservice and the target version identifier; and

call the adapter matching the database file set corresponding to the target subservice, and execute at least one database file in the database file set corresponding to the target subservice, to obtain the data information of the target subservice after adjustment, a version identifier of the at least one database file belonging to the version identifier interval.

In some embodiments, the database file set corresponding to the target subservice includes a plurality of database files belonging to the version identifier interval. The processing unit 602 is specifically configured to:

call the adapter matching the database file set corresponding to the target subservice, and sequentially execute to-be-executed database files in a target order, to obtain the data information of the target subservice after adjustment;

the to-be-executed database files including database files belonging to the version identifier interval in the database file set corresponding to the target subservice; and the target order being determined according to an adjustment policy of the target subservice, and the adjustment policy of the target subservice being determined according to the current version identifier of the target subservice and the target version identifier.

In some embodiments, an identifier of each database file carries an adjustment type field. The processing unit 602 is specifically configured to:

determine an adjustment policy according to the current version identifier of the target subservice and the target version identifier; and

sift out the to-be-executed database file from the database file set corresponding to the target subservice according to the adjustment policy, an adjustment type field of the to-be-executed database file matching the adjustment policy.

In some embodiments, data information of each of the P subservices carries a current version identifier. The processing unit 602 is specifically configured to:

based on successful adjustment of the P subservices,

replace each of current version identifiers of the P subservices with the target version identifier.

In some embodiments, the obtaining unit 601 is configured to: obtain a target image corresponding to the target subservice in the N subservices; create a target container based on the target image, and extract a database file from the target image through the target container, to obtain the database file set of the target subservice, the database file set of the target subservice including: database files of different versions under the target subservice, the database file in the database file set of the target subservice being named according to a version identifier to which the database file belongs; and generate the software installation package of the target application according to the database file set of the target subservice;

or

the software installation package being sent by a target computer device to the computer device; the target computer device being configured to obtain a target image corresponding to the target subservice in the N subservices; create a target container based on the target image, and extract a database file from the target image through the target container, to obtain the database file set of the target subservice, the database file set of the target subservice including: database files of different versions under the target subservice, the database file in the database file set of the target subservice being named according to a version identifier to which the database file belongs; and generate the software installation package of the target application according to the database file set of the target subservice.

In some embodiments, the N subservices belong to M service types, M is a positive integer, and M is less than or equal to N; and the software installation package of the target application is obtained by classifying and packaging the N database file sets according to the M service types.

According to some embodiments, some of the operations involved in the data processing methods for an application shown in FIG. 3 and FIG. 4 may be performed by the units in the data processing apparatus for an application shown in FIG. 8. For example, operation S201 shown in FIG. 3 may be performed by the obtaining unit 601 shown in FIG. 8, and operation S202 and operation S203 may be performed by the processing unit 602 shown in FIG. 8. Operation S301 shown in FIG. 4 may be performed by the obtaining unit 601 shown in FIG. 8, and operation S302 to operation S305 may be performed by the processing unit 602 shown in FIG. 8. The units of the data processing apparatus for an application shown in FIG. 8 may be separately or wholly combined into one or several other units, or one (or more) of the units herein may be further divided into a plurality of units of smaller functions. The foregoing units are divided based on logical functions. In an actual application, a function of one unit may also be implemented by a plurality of units, or functions of a plurality of units are implemented by one unit. In some embodiments, the data processing apparatus for an application may also include other units. In some embodiments, the functions may also be cooperatively implemented by other units and may be cooperatively implemented by a plurality of units. A person skilled in the art would understand that these “units” could be implemented by hardware logic, a processor or processors executing computer software code, or a combination of both.

According to some embodiments, a data processing apparatus for an application shown in FIG. 8 may be constructed and a data processing method for an application may be performed by running a computer program (including program code) that can perform the operations involved in the corresponding methods shown in FIG. 3 and FIG. 4 on processing elements and memory elements including a central processing unit (CPU), a random access memory (RAM), a read-only memory (ROM), and the like, for example, generic computing devices of computers. The computer program may be recorded in, for example, a computer-readable recording medium, and may be loaded into the foregoing computing device by using the computer-readable recording medium, and run on the computing device.

Based on the same inventive idea, the problem solving principles and beneficial effects of the data processing apparatuses for an application provided in the embodiments are similar to the problem solving principles and beneficial effects of the data processing apparatuses for an application in the method according to some embodiments. For the principles and beneficial effects, refer to the principles and beneficial effects. For ease of description, details are not described herein again.

FIG. 9 is a schematic structural diagram of a computer device according to some embodiments. The computer device includes at least a processor 701, a communication interface 702, and a memory 703. The processor 701, the communication interface 702, and the memory 703 may be connected through a bus or in another manner. The processor 701 (or referred to as a central processing unit (CPU)) is a computing core and control core of the terminal. The processor can parse various instructions in a terminal and process various data of the terminal. For example, the CPU can be configured to parse a power-on/off instruction sent by a user to the terminal and control the terminal to perform a power-on/off operation. For another example, the CPU can transmit various types of interaction data between structures inside the terminal, and so on. The communication interface 702 may include a standard wired interface or wireless interface (for example, WI-FI or a mobile communication interface), and may be configured to receive and send data under control of the processor 701. The communication interface 702 may be further configured for transmission and interaction of data inside the terminal. The memory 703 is a storage device in the terminal and is configured to store a program and data. It may be understood that the memory 703 herein may include an internal memory of the terminal and certainly may also include an extended memory supported by the terminal. The memory 703 provides a storage space, and the storage space stores an operating system of the terminal. The operating system may include, but is not limited to: an Android system, an iOS system, a Windows Phone system, and the like. This is not limited herein.

In some embodiments, the processor 701 runs executable program code in the memory 703 to perform the following operations:

obtaining, through the communication interface 702, a software installation package of a target application based on an adjustment instruction for the target application, the adjustment instruction carrying a target version identifier, the target application including N subservices, the software installation package including N database file sets in a one-to-one correspondence with the N subservices, the N database file sets being obtained from N images in a one-to-one correspondence with the N subservices, and N being a positive integer;

adjusting, according to P database file sets in the N database file sets, P subservices in the N subservices to a version indicated by the target version identifier, to obtain data information of P adjusted subservices, P being a positive integer, and P being less than or equal to N; and

storing the data information of the P adjusted subservices in a database to obtain an adjusted target application.

In some embodiments, in which the processor 701 obtains the software installation package of the target application is:

obtaining a target image corresponding to the target subservice in the N subservices;

creating a target container based on the target image, and extracting a database file from the target image through the target container, to obtain the database file set of the target subservice, the database file set of the target subservice including: database files of different versions under the target subservice, the database file in the database file set of the target subservice being named according to a version identifier to which the database file belongs; and

generating the software installation package of the target application according to the database file set of the target subservice.

In some embodiments, in which the processor 701 adjusts, according to the P database file sets in the N database file sets, the P subservices in the N subservices to the version indicated by the target version identifier is:

determining P to-be-adjusted subservices in the N subservices according to a filtering rule;

determining an adapter matching a database file set corresponding to a target subservice according to a type of the database file in the database file set corresponding to the target subservice, the target subservice being any subservice in the P to-be-adjusted subservices determined in the N subservices according to the filtering rule; and

adjusting the target subservice by using the adapter matching the database file set corresponding to the target subservice, to obtain data information of the target subservice after adjustment.

In some embodiments, each image includes at least one database file, and the at least one database file each carries an identifier of a corresponding database. In some embodiments the processor 701 adjusts the target subservice by using the adapter matching the database file set corresponding to the target subservice, to obtain the data information of the target subservice after adjustment is:

determining a version identifier interval according to a current version identifier of the target subservice and the target version identifier; and

calling the adapter matching the database file set corresponding to the target subservice, and executing at least one database file in the database file set corresponding to the target subservice, to obtain the data information of the target subservice after adjustment, a version identifier of the at least one database file belonging to the version identifier interval.

In some embodiments, the database file set corresponding to the target subservice includes a plurality of database files belonging to the version identifier interval. An example embodiment in which the processor 701 calls the adapter matching the database file set corresponding to the target subservice, and executes the at least one database file in the database file set corresponding to the target subservice, to obtain the data information of the target subservice after adjustment is:

calling the adapter matching the database file set corresponding to the target subservice, and sequentially executing database files belonging to the version identifier interval in the database file set corresponding to the target subservice in a target order, to obtain the data information of the target subservice after adjustment;

the target order being determined according to an adjustment policy of the target subservice, and the adjustment policy of the target subservice being determined according to the current version identifier of the target subservice and the target version identifier.

In some embodiments, an identifier of each database file carries an adjustment type field. An example embodiment in which the processor 701 calls the adapter matching the database file set corresponding to the target subservice, and executes the at least one database file in the database file set corresponding to the target subservice, to obtain the data information of the target subservice after adjustment is:

determining an adjustment policy according to the current version identifier of the target subservice and the target version identifier; and

sifting out the to-be-executed database file from the database file set corresponding to the target subservice according to the adjustment policy, an adjustment type field of the to-be-executed database file matching the adjustment policy; and

calling the adapter matching the database file set corresponding to the target subservice, and executing to-be-executed database files, to obtain the data information of the target subservice after adjustment.

In some embodiments, data information of each of the P subservices carries a current version identifier. An example embodiment in which the processor 701 adjusts, according to P database file sets in the N database file sets, P subservices in the N subservices to a version indicated by the target version identifier, to obtain data information of P adjusted subservices is:

based on successful adjustment of the P subservices,

replacing each of current version identifiers of the P subservices with the target version identifier, to obtain data information of P adjusted subservices.

In some embodiments, the N subservices belong to M service types, M is a positive integer, and M is less than or equal to N; and the software installation package of the target application is obtained by classifying and packaging the N database file sets according to the M service types.

Based on the same inventive idea, the problem solving principles and beneficial effects of the computer device provided in some embodiments are similar to the problem solving principles and beneficial effects of the data processing methods for an application in the method embodiments. For the principles and beneficial effects, refer to the principles and beneficial effects of the implementations of the methods. For ease of description, details are not described herein again.

Some embodiments further provide a non-transitory computer-readable storage medium, the computer-readable storage medium storing one or more instructions, the one or more instructions being suitable for loading by a processor to perform the data processing method for an application in the foregoing method embodiments.

A person of ordinary skill in the art can understand that, all or some operations in the methods in the foregoing embodiments may be performed by a program instructing related hardware. The program may be stored in a computer-readable storage medium. The readable storage medium may include: a flash drive, a read-only memory (ROM), a random access memory (RAM), a magnetic disk, an optical disc, and the like.

Some embodiments further provide a computer program product including instructions, the computer program product, when run on a computer, causing the computer to perform the data processing method for an application in the foregoing method embodiments.

Some embodiments further provide a computer program product or a computer program. The computer program product or the computer program includes computer instructions, and the computer instructions are stored in a computer-readable storage medium. A processor of a computer device reads the computer instructions from the computer-readable storage medium, and executes the computer instructions, to cause the computer device to perform the data processing method for an application described above.

The operations in the methods according to some embodiments may be rearranged, combined, and deleted according to actual needs.

The modules in the apparatuses according to some embodiments may be combined, divided, and deleted according to actual needs.

What is claimed is:

1. A data processing method for an application, performed by a computer device, comprising:
obtaining a software installation package of a target application based on an adjustment instruction carrying a target version identifier for the target application, the target application comprising N subservices, the software installation package comprising N database file sets in a one-to-one correspondence with the N subservices, the N database file sets being obtained from N images in a one-to-one correspondence with the N subservices, and N being a positive integer;
adjusting, according to P database file sets of the N database file sets, P subservices of the N subservices to a version indicated by the target version identifier to obtain data information of P adjusted subservices, P being a positive integer less than or equal to N; and
storing the data information of the P adjusted subservices in a database to obtain an adjusted target application.

2. The data processing method according to claim 1, wherein the adjusting comprises:
determining P to-be-adjusted subservices of the N subservices according to a filtering rule;
determining an adapter matching a database file set corresponding to a target subservice according to a type of a database file in the database file set corresponding to the target subservice, the target subservice being any subservice in the P to-be-adjusted subservices;
adjusting the target subservice by using the adapter matching the database file set corresponding to the target subservice to obtain data information of the adjusted target subservice; and
repeating the determining the adapter, and the adjusting the target subservice to adjust the P subservices in the N subservices to the version indicated by the target version identifier.

3. The data processing method according to claim 2, wherein each of the N images comprises at least one database file, and each of the at least one database file carries an identifier of a corresponding database; and the adjusting the target subservice comprises:
determining a version identifier interval according to a current version identifier of the target subservice and the target version identifier; and
calling the adapter matching the database file set corresponding to the target subservice, and executing at least one database file in the database file set corresponding to the target subservice to obtain the data information of the adjusted target subservice, a version identifier of the at least one database file belonging to the version identifier interval.

4. The data processing method according to claim 3, wherein the database file set corresponding to the target subservice comprises a plurality of database files belonging to the version identifier interval; and
the calling comprises:
calling the adapter matching the database file set corresponding to the target subservice, and sequentially executing to-be-executed database files in a target order, to obtain the data information of the adjusted target subservice;
the to-be-executed database files comprising database files belonging to the version identifier interval in the database file set corresponding to the target subservice; and the target order being determined according to an adjustment policy of the target subservice, and the adjustment policy of the target subservice being determined according to the current version identifier of the target subservice and the target version identifier.

5. The data processing method according to claim 4, wherein the identifier of each database file of the plurality of database files carries an adjustment type field; and the data processing method further comprises:
determining the adjustment policy according to the current version identifier of the target subservice and the target version identifier; and
sifting out the to-be-executed database file from the database file set corresponding to the target subservice according to the adjustment policy, the adjustment type field of the to-be-executed database file matching the adjustment policy.

6. The data processing method according to claim 1, wherein data information of each of the P subservices carries a current version identifier; and
the data processing method further comprises:
based on successful adjustment of the P subservices, replacing each of current version identifiers of the P subservices with the target version identifier.

7. The data processing method according to claim 1, further comprising one of:
obtaining a target image corresponding to a target subservice in the N subservices; creating a target container based on the target image, and extracting a database file from the target image through the target container to obtain a database file set of the target subservice, the database file set of the target subservice comprising: database files of different versions under the target subservice, the database file in the database file set of the target subservice being named according to a version identifier to which the database file belongs; and generating the software installation package of the target application according to the database file set of the target subservice; and
receiving the software installation package from a target computer device; the target computer device being configured to obtain the target image corresponding to the target subservice in the N subservices; creating the target container based on the target image, and extracting the database file from the target image through the target container, to obtain the database file set of the target subservice, the database file set of the target subservice comprising: the database files of different versions under the target subservice, the database file in the database file set of the target subservice being named according to the version identifier to which the database file belongs; and generating the software installation package of the target application according to the database file set of the target subservice.

8. The data processing method according to claim 7, wherein the N subservices belong to M service types, M is a positive integer less than or equal to N; and the software installation package of the target application is obtained by classifying and packaging the N database file sets according to the M service types.

9. A data processing apparatus for an application, comprising:
at least one memory configured to store program code; and
at least one processor configured to read the program code and operate as instructed by the program code, the program code comprising:
obtaining code configured to cause the at least one processor to obtain a software installation package of a target application based on an adjustment instruction for the target application, the adjustment instruction carrying a target version identifier, the target application comprising N subservices, the software installation package comprising N database file sets in a one-to-one correspondence with the N subservices, the N database file sets being obtained from N images in a one-to-one correspondence with the N subservices, and N being a positive integer; and
processing code configured to cause the at least one processor to adjust, according to P database file sets in the N database file sets, P subservices in the N subservices to a version indicated by the target version identifier, to obtain data information of P adjusted subservices, P being a positive integer less than or equal to N; and store the data information of the P adjusted subservices in a database to obtain an adjusted target application.

10. The data processing apparatus according to claim 9, wherein the processing code is further configured to cause the at least one processor to:
determine P to-be-adjusted subservices of the N subservices according to a filtering rule;
determine an adapter matching a database file set corresponding to a target subservice according to a type of the database file in the database file set corresponding to the target subservice, the target subservice being any subservice in the P to-be-adjusted subservices determined in the N subservices according to the filtering rule;
adjust the target subservice by using the adapter matching the database file set corresponding to the target subservice to obtain data information of the adjusted target subservice; and
repeat the determine the adapter and adjust the target subservice to adjust the P subservices in the N subservices to the version indicated by the target version identifier.

11. The data processing apparatus according to claim 10, wherein each image comprises at least one database file, and each of the at least one database file carries an identifier of a corresponding database; and
the processing code is further configured to cause the at least one processor to:
determine a version identifier interval according to a current version identifier of the target subservice and the target version identifier; and
call the adapter matching the database file set corresponding to the target subservice, and execute at least one database file in the database file set corresponding to the target subservice to obtain the data information of the adjusted target subservice, a version identifier of the at least one database file belonging to the version identifier interval.

12. The data processing apparatus according to claim 11, wherein the database file set corresponding to the target subservice comprises a plurality of database files belonging to the version identifier interval; and
the processing code is further configured to cause the at least one processor to:
call the adapter matching the database file set corresponding to the target subservice, and sequentially execute to-be-executed database files in a target order, to obtain the data information of the adjusted target subservice;
the to-be-executed database files comprising database files belonging to the version identifier interval in the database file set corresponding to the target subservice; and the target order being determined according to an adjustment policy of the target subservice, and the adjustment policy of the target subservice being determined according to the current version identifier of the target subservice and the target version identifier.

13. The data processing apparatus according to claim 12, wherein the identifier of each database file of the plurality of database files carries an adjustment type field; and the processing code is further configured to cause the at least one processor to:
determine the adjustment policy according to the current version identifier of the target subservice and the target version identifier; and
sift out the to-be-executed database file from the database file set corresponding to the target subservice according to the adjustment policy, the adjustment type field of the to-be-executed database file matching the adjustment policy.

14. The data processing apparatus according to claim 9, wherein data information of each of the P subservices carries a current version identifier; and
the processing code is further configured to cause the at least one processor to:
based on successful adjustment of the P subservices, replace each of current version identifiers of the P subservices with the target version identifier.

15. The data processing apparatus according to claim 9, wherein the obtaining code is further configured to cause the at least one processor to perform one of:
obtain a target image corresponding to a target subservice in the N subservices; create a target container based on the target image, and extract a database file from the target image through the target container to obtain a database file set of the target subservice, the database file set of the target subservice comprising: database files of different versions under the target subservice, the database file in the database file set of the target subservice being named according to a version identifier to which the database file belongs; and generate the software installation package of the target application according to the database file set of the target subservice; and
receive the software installation package from a target computer device; the target computer device being configured to obtain the target image corresponding to the target subservice in the N subservices; create the target container based on the target image, and extract the database file from the target image through the target container to obtain the database file set of the target subservice, the database file set of the target subservice comprising: the database files of different versions under the target subservice, the database file in the database file set of the target subservice being named according to the version identifier to which the database file belongs; and generate the software installation package of the target application according to the database file set of the target subservice.

16. The data processing apparatus according to claim 15, wherein the N subservices belong to M service types, M is a positive integer less than or equal to N; and the software installation package of the target application is obtained by classifying and packaging the N database file sets according to the M service types.

17. A non-transitory computer-readable storage medium, storing a computer code that when executed by at least one processor causes the at least one processor to:
obtain a software installation package of a target application based on an adjustment instruction for the target application, the adjustment instruction carrying a target version identifier, the target application comprising N subservices, the software installation package comprising N database file sets in a one-to-one correspondence with the N subservices, the N database file sets being obtained from N images in a one-to-one correspondence with the N subservices, and N being a positive integer;
adjust, according to P database file sets of the N database file sets, P subservices of the N subservices to a version indicated by the target version identifier to obtain data information of P adjusted subservices, P being a positive integer less than or equal to N; and
store the data information of the P adjusted subservices in a database to obtain an adjusted target application.

18. The non-transitory computer-readable storage medium according to claim 17, wherein the adjust comprises:
determining P to-be-adjusted subservices of the N subservices according to a filtering rule;
determining an adapter matching a database file set corresponding to a target subservice according to a type of the database file in the database file set corresponding to the target subservice, the target subservice being any subservice in the P to-be-adjusted subservices determined in the N subservices according to the filtering rule;
adjusting the target subservice by using the adapter matching the database file set corresponding to the target subservice to obtain data information of the adjusted target subservice; and
repeating the determining the P to-be-adjusted subservices, determining the adapter, and adjusting the target subservice to adjust the P subservices in the N subservices to the version indicated by the target version identifier.

19. The non-transitory computer-readable storage medium according to claim 18, wherein each image comprises at least one database file, and each of the at least one database file carries an identifier of a corresponding database; and the adjusting the target subservice comprises:
determining a version identifier interval according to a current version identifier of the target subservice and the target version identifier; and
calling the adapter matching the database file set corresponding to the target subservice, and executing at least one database file in the database file set corresponding to the target subservice to obtain the data information of the adjusted target subservice, a version identifier of the at least one database file belonging to the version identifier interval.

20. The non-transitory computer-readable storage medium according to claim 19, wherein the database file set corresponding to the target subservice comprises a plurality of database files belonging to the version identifier interval; and
the calling comprises:
calling the adapter matching the database file set corresponding to the target subservice, and sequentially executing to-be-executed database files in a target order, to obtain the data information of the adjusted target subservice;
the to-be-executed database files comprising database files belonging to the version identifier interval in the database file set corresponding to the target subservice; and the target order being determined according to an adjustment policy of the target subservice, and the adjustment policy of the target subservice being determined according to the current version identifier of the target subservice and the target version identifier.
